(19) United States
(12) Patent Application Publication
(10) Pub. No.: US 2013/0132228 A1
(43) Pub. Date: May 23, 2013

(54) COLLABORATIVE ELECTRONIC CARD CREATION PLATFORM

(71) Applicant: DeJay CHANG, New Taipei City (TW)

(72) Inventor: DeJay CHANG, New Taipei City (TW)

(21) Appl. No.: 13/303,963

(22) Filed: Nov. 23, 2011

(51) Int. Cl. G06Q 30/02; G06F 15/16

(52) U.S. Cl. 705/26.5; 709/203

(57) ABSTRACT

A platform and method for creating an electronic card by a plurality of users cooperating together to produce the electronic card (e-card) is disclosed. A member of the platform creates and designs an e-card for an intended recipient. Other users are invited to add content to the e-card. Users select gifts and memories to add to the e-card for the recipient. E-commerce, advertising, licensing, merchandising, electronic points, and marketing groups cooperate with the platform to provide products, services, and rewards via the platform to users. The platform receives revenue from the interaction and sales between the groups and the users or members of the platform. The e-card is published to components of a publishing group such as a social network. A database is provided for storing user, platform, and group activity.

### BACKGROUND OF THE INVENTION

1. Field of the Invention

The present invention relates to electronic cards. More specifically, the present invention discloses a platform and method for creating an electronic card by a plurality of users collaborating together.

2. Description of the Prior Art

Greeting cards are commonly given to friends to express or convey a particular emotional feeling for a specific occasion. The conventional greeting card is made of paper and is produced by a card manufacturer with a printed greeting. A person that wants to give a conventional card to someone must browse a selection of cards in a store and try to find a card with a greeting appropriate with the occasion.

However, since the purchased card is produced by a manufacturer unrelated to the person or the occasion, the emotional impact or accuracy of the feeling to be conveyed is less than desirable.

After buying the card the person signs their name on the card prior to giving the card to someone. If more than one person wants to sign the card, the card must be taken to the other person or the other person must travel to the card's physical location. This is very inconvenient particularly when people are in various locations or when a relatively large number of people want to sign the card.

Therefore, there is need for a platform and method for creating an electronic card that allows a plurality of users to conveniently collaborate together to easily produce the electronic card.

### SUMMARY OF THE INVENTION

To achieve these and other advantages and in order to overcome the disadvantages of the conventional methods in accordance with the purpose of the invention as embodied and broadly described herein, the present invention provides a simple and effective platform and method for creating an electronic card (e-card) for a recipient by a plurality of users collaborating together.

A host initiates the e-card creation process by setting up the basic e-card layout. The host selects the intended recipient that the card will be sent to. Also, the host chooses a desired graphic or multiple graphics to be displayed on the card and inputs an appropriate greeting for the card's message.

A plurality of users is also designated by the host. The plurality of users cooperate together to create content for the e-card. Once the host has set up the e-card framework described above, the plurality of users is notified that an e-card intended for a specific person has be set up by the host and the users are invited to add to the e-card. Each user that wants to participate in creating the e-card adds their signature or name and a wish or wishes to the recipient. As each user provides their content, the content is added to the e-card.

When the host decides the e-card is satisfactorily complete, the host publishes the e-card. For example, the e-card is published to a social network, the e-card is sent to the intended recipient, a hyperlink is generated for the e-card and the link is shared, etc.

When the recipient views the e-card they can see the graphics and greeting that the host established and see the individual names and wishes from the plurality of users who participated.

A gift module is provided to allow users to add gifts to the recipient in the e-card. When the recipient receives the e-card they can see what gifts have been given to them and who sent the gift.

A memories module is provided to allow users to add content in addition to the wishes. For example, a user can add photos and videos to the e-card that the recipient will be able to see. This allows the present invention to produce an e-card with much more emotional impact.

If they desire, the recipient can make the e-card public for others to see. This encourages other users to participate in creating e-cards when given future opportunities.

Users that have contributed to the e-card are allowed to make their content or parts of their content private so that only the recipient can see the content or only the recipient and other contributors can see the content or the content can be made public for all to see.

The platform of the present invention earns revenue by cooperating with affiliates to offer products and services to users for purchase as gifts, merchandisers for sale of products to users, and from advertisers.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a drawing illustrating a network system utilizing a collaborative e-card creation and publishing platform according to an embodiment of the present invention;

FIG. 1B is a drawing illustrating a block diagram of modules of the collaborative e-card creation and publishing platform according to an embodiment of the present invention;

FIG. 1C is a drawing illustrating a collaborative e-card according to an embodiment of the present invention;

FIG. 2A is a drawing illustrating a greetings page of a multiple page collaborative e-card according to an embodiment of the present invention;

FIG. 2B is a drawing illustrating a signature and wishes page of a multiple page collaborative e-card according to an embodiment of the present invention;

FIG. 2C is a drawing illustrating a gifts page of a multiple page collaborative e-card according to an embodiment of the present invention;

FIG. 2D is a drawing illustrating a memories page of a multiple page collaborative e-card according to an embodiment of the present invention;

FIG. 3A is a drawing illustrating a host card creator and publishing module of a collaborative e-card creation and publishing platform according to an embodiment of the present invention;

FIG. 3B is a drawing illustrating a card editor module of a collaborative e-card creation and publishing platform according to an embodiment of the present invention;

FIG. 4A is a drawing illustrating a signature and wishes editor module of a collaborative e-card creation and publishing platform according to an embodiment of the present invention;

FIG. 4B is a drawing illustrating a gift module of a collaborative e-card creation and publishing platform according to an embodiment of the present invention;

FIG. 4C is a drawing illustrating a memories editor module of a collaborative e-card creation and publishing platform according to an embodiment of the present invention;

FIGS. 5A-5B are flowcharts illustrating methods for e-card creation of a collaborative e-card creation and publishing platform according to embodiments of the present invention;

FIGS. 5C-5F are flowcharts illustrating methods for e-card editing of a collaborative e-card creation and publishing platform according to embodiments of the present invention; and

FIG. 6 is a flowchart illustrating a method for redeeming electronic points of a collaborative e-card creation and publishing platform according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

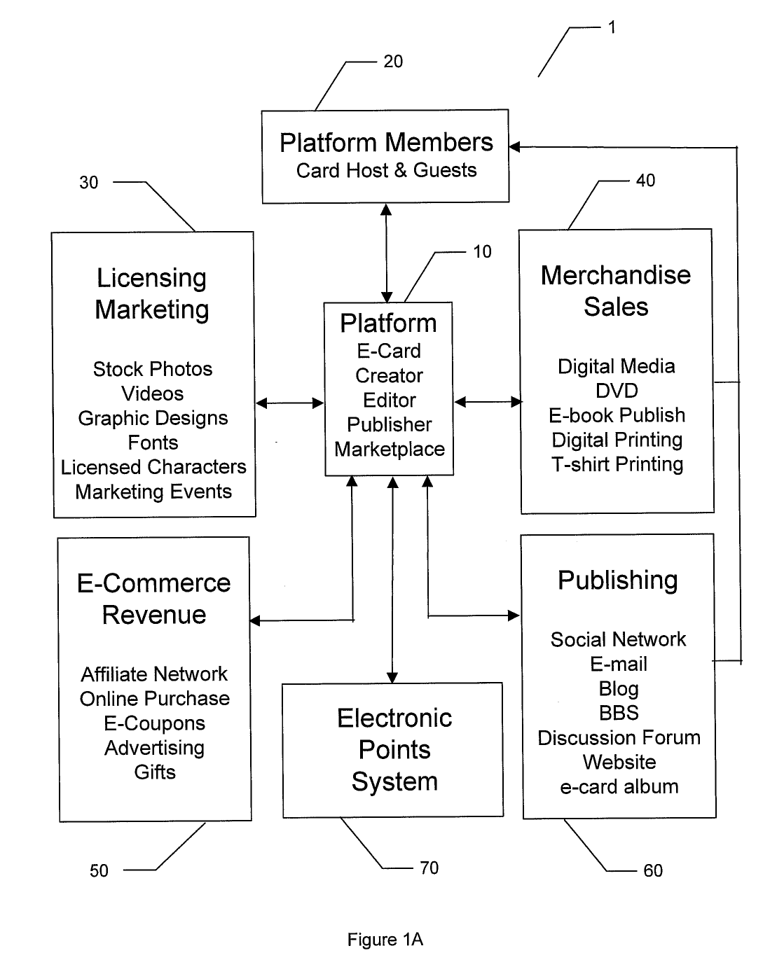

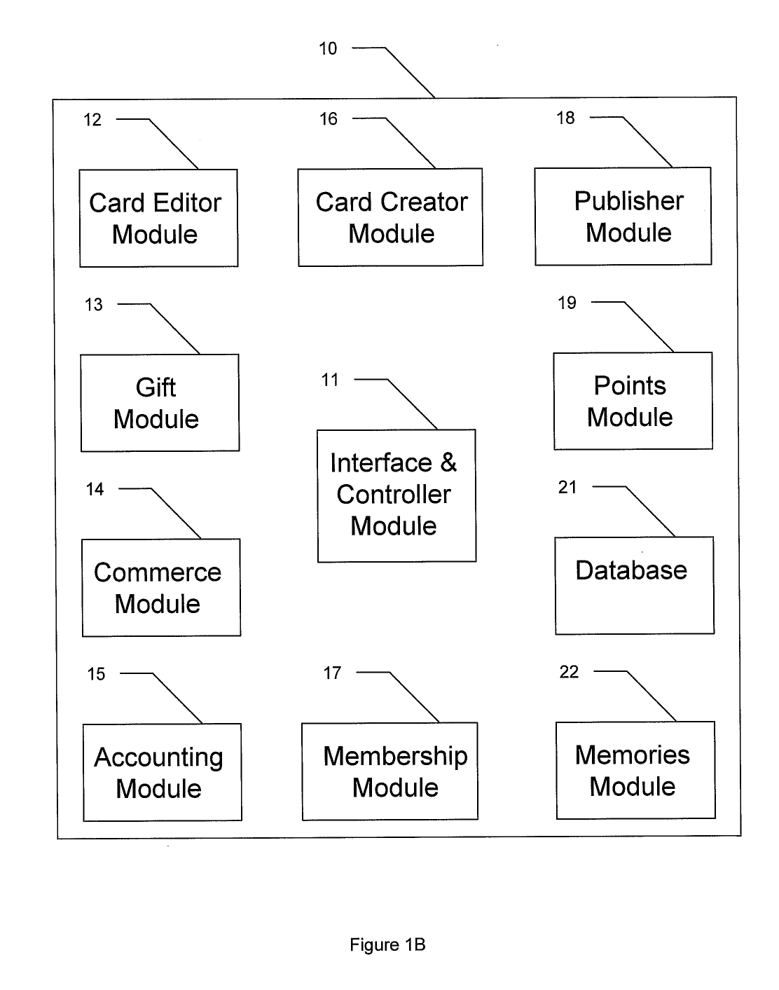

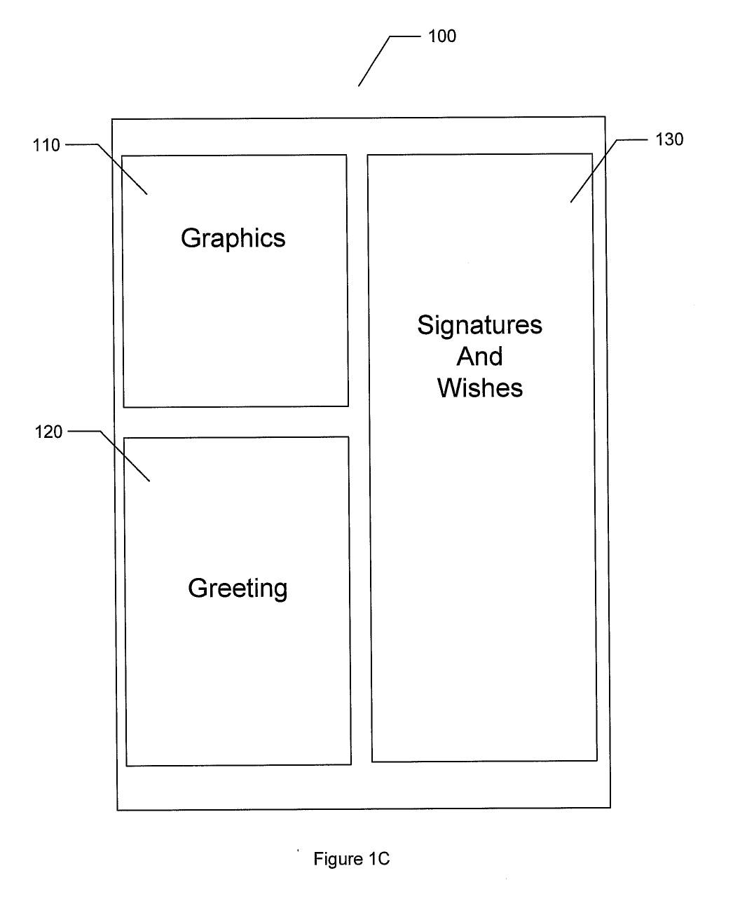

FIG. 1A is a drawing illustrating a network system utilizing a collaborative e-card creation and publishing platform according to an embodiment of the present invention.

The network system 1 comprises a collaborative e-card creation and publishing platform 10, a plurality of platform members group 20, a licensing marketing group 30, an electronic commerce (e-commerce) and revenue group 50, an electronic points system 70, a merchandise sales group 40, and a publishing group 60.

The collaborative e-card creation and publishing platform 10 is the integral core of the network system 1. The collaborative e-card creation and publishing platform 10 allows users to create an e-card and allow other users to contribute content to the e-card. After the invited users that wish to collaborate on the e-card have participated or the event/occasion date is reached, the platform 10 publishes the e-card. The collaborative e-card creation and publishing platform 10 also acts as a marketplace for interfacing between e-commerce affiliates, users, and merchandise sales groups.

The plurality of platform members group 20 comprises users who have registered with the collaborative e-card creation and publishing platform 10. If a user is invited to participate or has been introduced to the platform 10 and wants to participate or join, the user is given the opportunity to register and become a member of the platform 10. After becoming a registered member of the platform the user logs into the platform to create or edit an e-card or perform various actions available to members of the platform 10.

The licensing marketing group 30 comprises content providers with the rights to license or market content to the platform 10. The content comprises, for example, stock photographs and videos, commercial photographs and videos, graphic designs, themes, fonts, animation characters, marketing events, brands, products, or services. A cooperation between the licensing marketing group 30 and the platform 10 allows users to add licensed content to their e-cards. The cooperation with licensing agreements allows the content provider to receive a licensing fee for their content that is used in user's e-cards.

In an embodiment of the present invention the licensing fee paid to the content provider is received by the platform 10 from the platform member who utilized the licensed content.

In an embodiment of the present invention an additional service fee is paid to the platform 10 in addition to the licensing fee or a service fee is paid to the platform 10 from the licensing fee.

Marketing opportunities from the licensing marketing group 30 are also available to the platform 10. Companies or brands can provide content for products or services to the platform 10 for users to add to their e-card. For example, a brand has a product with a humorous viral video or logo that users can utilize to add humor to their e-card.

In an embodiment of the present invention the platform 10 or the platform 10 and the platform members 20 who utilize the content in their e-card are compensated with a commission or reward.

The electronic commerce (e-commerce) and revenue group 50 comprises products and services providers. The products and services providers comprise, for example, affiliate networks that cooperate with the platform 10 to offer products and services available for purchase to members of the platform 10, e-coupon groups and networks for providing offers in the form of e-coupons, advertisers who want to advertise on the platform 10 or inside the platform 10, and product and services providers who offer products and services to users via the platform 10 to be purchased as gifts for other users.

The cooperation between the electronic commerce and revenue group 50 and the platform 10 allows both to profit from purchases made by users and by advertising to users.

In an embodiment of the present invention the platform 10 receives a service fee in addition to the purchase price of the product or service.

In an embodiment of the present invention the platform 10 receives a service fee from the purchase price of the product or service.

The electronic points system 70 comprises a system cooperating with the e-points module of the present invention for issuing, redeeming, exchanging user's e-points. The electronic points system 70 provides a network that cooperates with the platform 10 to allow users to use, exchange, redeem, or cash in their accumulated e-points separate from purchasing products and services offered by the e-commerce revenue group 50.

In an embodiment of the present invention the platform 10 receives a commission or fee from user e-point activity and/or electronic points system 70 and user interaction.

The merchandise sales group 40 provides offers to users via the platform 10 of merchandise and services for published e-cards or e-card content. For example, the services and merchandise comprise e-book publishing, digital printing, T-shirt printing, and digital media publishing. Merchandise in addition to the electronic card can be purchased by users. For example, a digital video disc (DVD) can be purchased comprising the e-card stored on the DVD and the DVD can be saved or given to the recipient as a memento, a printed version of the e-book can be purchased, or an e-book comprising the e-card can be purchased.

In an embodiment of the present invention the platform 10 receives a fee or commission from user merchandise activity and/or merchandise sales group 40 and user interaction.

The publishing group 60 provides networks to allow users via the platform 10 to publish their e-cards. The publishing group 60 comprises, for example, social networks, email networks, blogs, bulletin board services, discussion forums, websites, and e-card albums.

In an embodiment of the present invention the card creator determines where the e-card will be published to.

In an embodiment of the present invention the platform 10 determines where to publish the e-card.

In an embodiment of the present invention the e-card is published to a plurality of components of the publishing group 60. For example, the e-card is published to a social network, an email, and an e-card album.

FIG. 1B is a drawing illustrating a block diagram of modules of the collaborative e-card creation and publishing platform according to an embodiment of the present invention.

In the embodiment of the present invention illustrated in FIG. 1B the collaborative e-card creation and publishing platform 10 comprises a plurality of modules. The modules perform the various functions of the platform 10.

The platform 10 comprises a card editor module 12, a card creator module 16, a publisher module 18, a gift module 13, a points module 19, an interface & controller module 11, a commerce module 14, a database 21, an accounting module 15, a membership module 17, and a memories module 22.

The card creator module 16 provides the functions needed to allow a user to create and design an e-card for collaboration.

The card editor module 12 provides the functions needed to allow a plurality of users to edit or add content to the e-card that another user created.

The publisher module 18 provides the functions needed to allow the user to publish the e-card or publish a hyperlink to the e-card.

The gift module 13 provides the functions needed to allow users to select and add products and services to the e-card to be given to the recipient of the e-card as gifts.

The points module 19 provides the functions needed to allow users to receive and redeem electronic points (e-points) for various activities such as creating a card, having other users sign the e-card, referring other users that become members and allows users to purchase e-points, or having invited users purchase gifts.

The commerce module 14 provides the functions needed to allow users to make purchases, affiliates to offer goods and services for purchase, content providers to offer licensed content, and merchandisers to offer merchandise for sale.

The accounting module 15 provides the functions needed to perform the financial accounting for the various commercial activities of the commerce module 14 and points module 19.

The membership module 17 provides the functions needed for membership actions and functions and to maintain user membership data for the platform 10 such as, for example, registering, login, user names, user passwords, and user e-points.

The memories module 22 provides the functions needed to allow users to add multimedia content to the e-card that is provided to the recipient of the e-card.

The database 21 provides the functions needed to maintain a database for the platform 10. The database 21 stores platform information such as, for example, user relationships, member activity, member actions, invited users, card creation, e-cards, recipients, occasions, dates of activity, dates of occasions, purchases, gifts, values of purchases and gifts, purchasing behavior, user interactions, user behavior, user's friends lists, e-point exchanges, products, hot offers activity, wish list data, affiliate data, merchandise data, or licensing data.

The interface & controller module 11 provides the functions needed for the various modules to interact with each other and the users to interact with the platform 10.

Refer to FIG. 1C, which is a drawing illustrating a collaborative e-card according to an embodiment of the present invention.

In the embodiment illustrated in FIG. 1B the collaborative e-card 100 comprises graphics 110, a greeting 120 and signatures and wishes 130.

The graphics 110 comprise graphical elements such as, for example, photos, drawings, geometrical shapes, animations, or colors. When creating the collaborative e-card 100 the host selects elements or designs appropriate for the theme or feeling of the e-card 100.

The greeting 120 comprises wording or phrases to convey the message of the e-card 100. For example, for a birthday card the host can select a greeting 120 comprising the words “Happy Birthday!”. Also, the host can select graphics 110 such as a picture of a birthday cake.

The signatures and wishes 130 comprise the signatures or names of the user's who have participated in collaborating in creating the e-card 100. Along with the signatures each user can add a personalized message or wishes that will appear along with their signature in the signatures and wishes 130. For example, a user adds their signature “Fred Smith” along with wishes “Hope you have a great one!”.

In an embodiment of the present invention the user adds their signature and/or wishes by typing their name and wishes.

In another embodiment of the present invention the user adds their signature and/or wishes by mouse input or by a touch display input by drawing their name and wishes so that the signature and wishes appears as they would if written or drawn by hand on paper.

In an embodiment of the present invention when the e-card is viewed the signatures and wishes are displayed in a linear time mode as the signatures and wishes were input. This allows the signatures and wishes to appear to be written in real-time. For example, with the user's signature “Fred Smith” the “F” would appear first and then the “r” and then the “e” and then the “d” would appear just as the user signed their name. Graphical elements added to the wishes are also displayed to appear as if they were being drawn in real-time.

Multiple pages of signatures and wishes 130 are added when needed to allow all interested users to add their own signatures and wishes 130. The recipient can page through the e-card 100 to view all of the signatures and wishes 130.

In an embodiment of the present invention users can also add a personal avatar along with their signature. The avatar comprises, for example, a cartoon, an image, a photo, or a picture that is displayed with the user's signature and wishes 130.

In an embodiment of the present invention users can also add graphical elements to their wishes. For example, users can draw or add an image to be displayed along with their wishes.

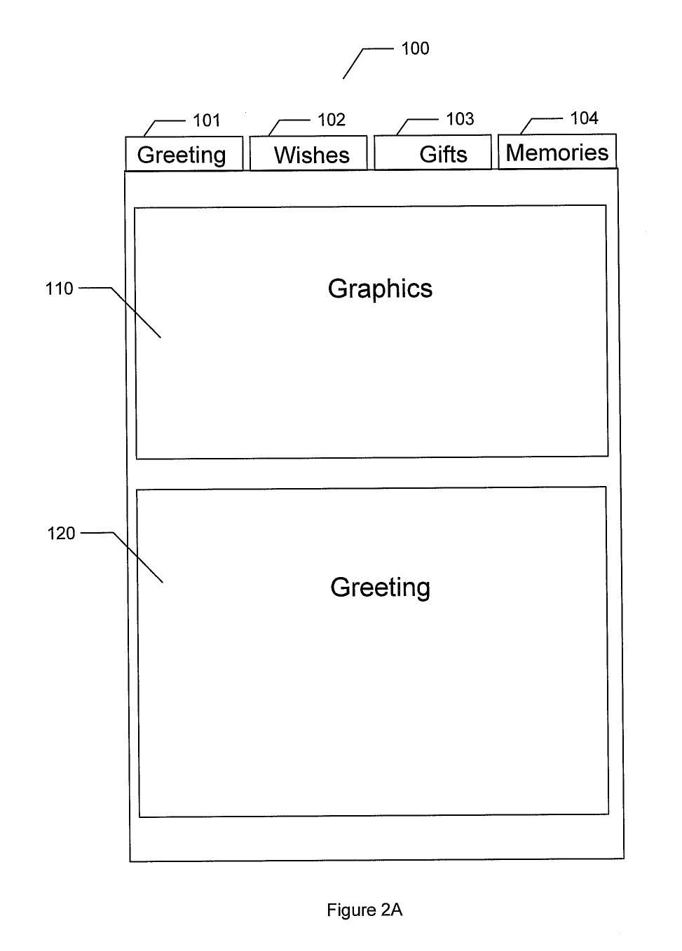

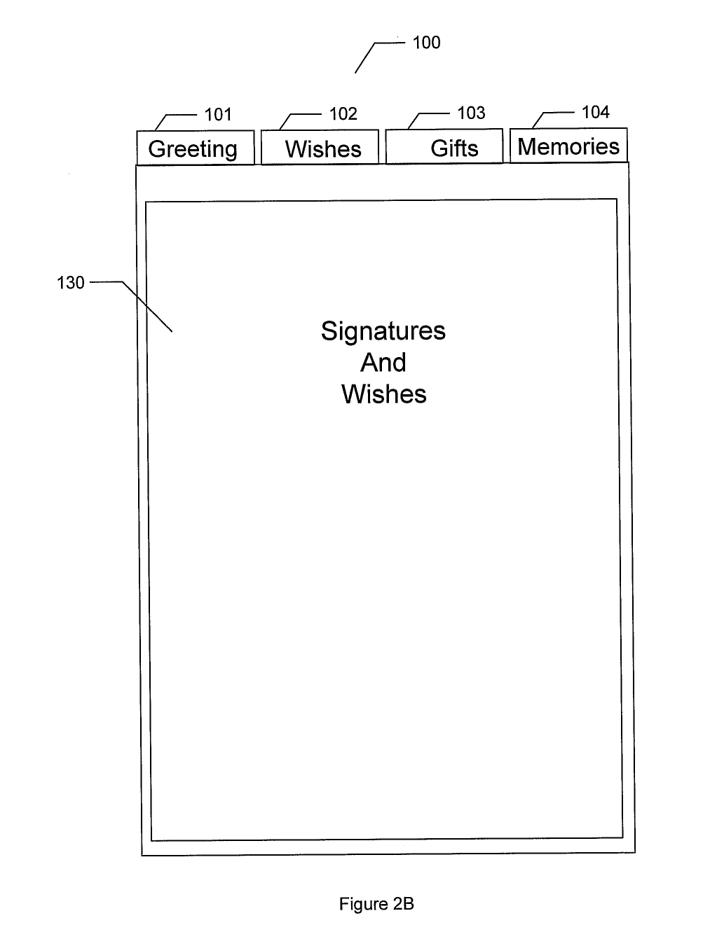

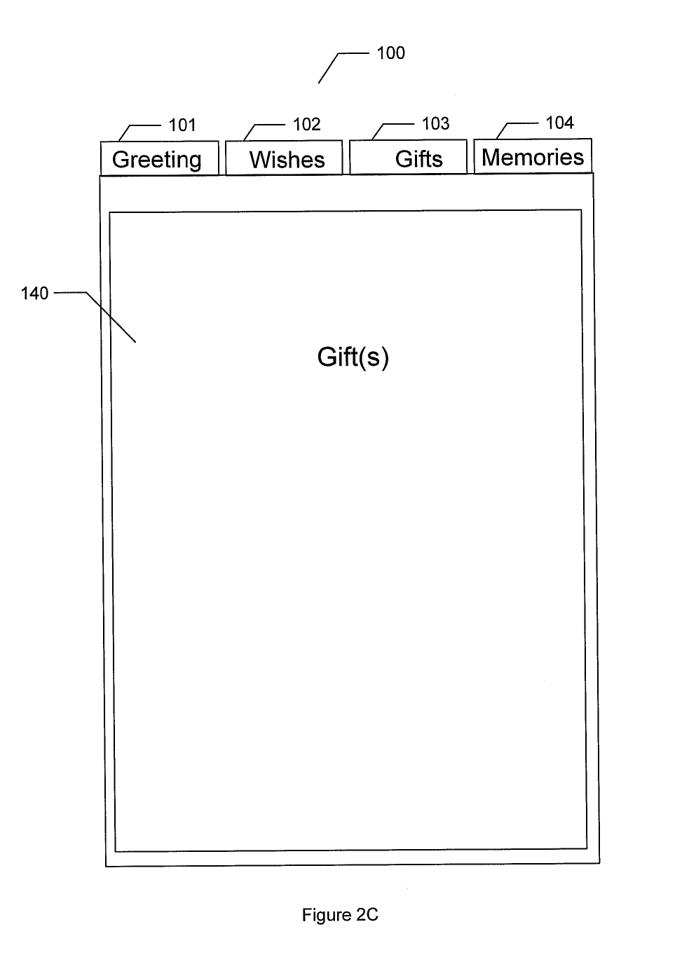

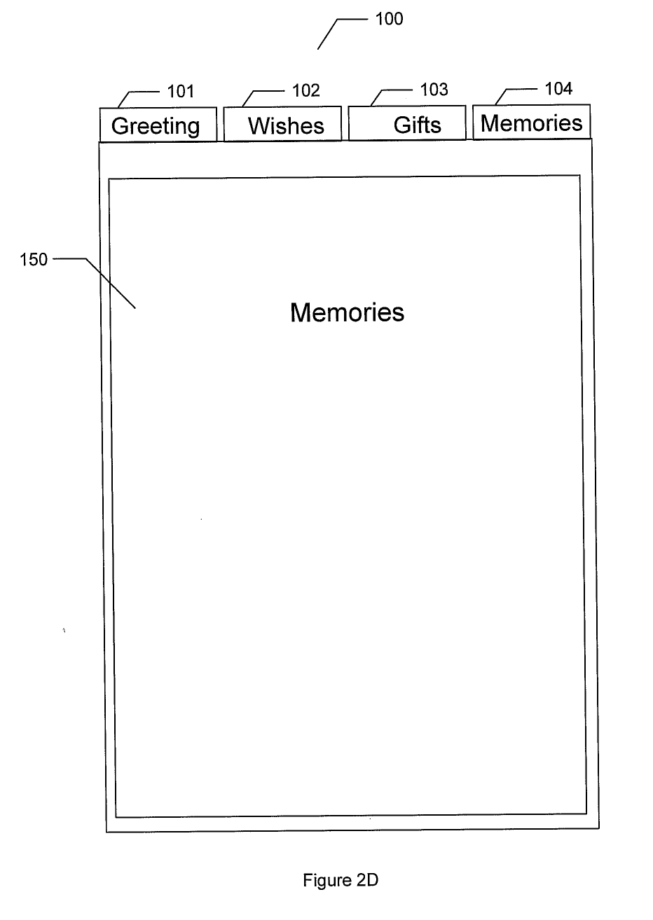

Refer to FIG. 2A, which is a drawing illustrating a greetings page of a multiple page collaborative e-card according to an embodiment of the present invention.

In the embodiment illustrated in FIG. 2A the collaborative e-card 100 comprises a plurality of pages and sections. For example, the e-card 100 comprises a greeting page 101, a signature and wishes page 102, a gifts page 103, and a memories page 104. Users and the recipient switch between the pages by selecting the associated tab or icon for the page category or type. For example, selecting the gifts tab takes the viewer to the gifts page.

The greetings page 101 of the collaborative e-card 100 comprises graphics 110 and a greeting 120 similar to the embodiment illustrated in FIG. 1.

Refer to FIG. 2B, which is a drawing illustrating a signature and wishes page of a multiple page collaborative e-card according to an embodiment of the present invention.

When a viewer of the e-card 100 selects the signatures and wishes page 102, the signatures and wishes added by the users who collaborated in creating the e-card 100 are displayed. Additional signatures and wishes pages 102 are added as needed to allow all users who want to sign the card to have space to add their signatures and wishes 130.

Refer to FIG. 2C, which is a drawing illustrating a gifts page of a multiple page collaborative e-card according to an embodiment of the present invention.

In the embodiment illustrated in FIG. 2C the collaborative e-card 100 further comprises a gifts page 103. Gifts that have been selected by users collaborating on the e-card are displayed in the gifts section 140 of the gifts page 103. The names of the user who gave the gift are also displayed to indicate the gift giver.

Refer to FIG. 2D, which is a drawing illustrating a memories page of a multiple page collaborative e-card according to an embodiment of the present invention.

In the embodiment illustrated in FIG. 2D the collaborative e-card 100 further comprises a memories page 104. The memories page 104 is provided to allow users to add content in addition to the wishes. For example, a user can add photos and videos to the e-card that the recipient will be able to see. This allows the present invention to produce an e-card with much more emotional impact.

For example, the e-card comprises a “Happy 50th Anniversary” occasion. A user can add a photo of the celebrating couple from their wedding day and the photo will be displayed in the memories section 150 of the memories page 104.

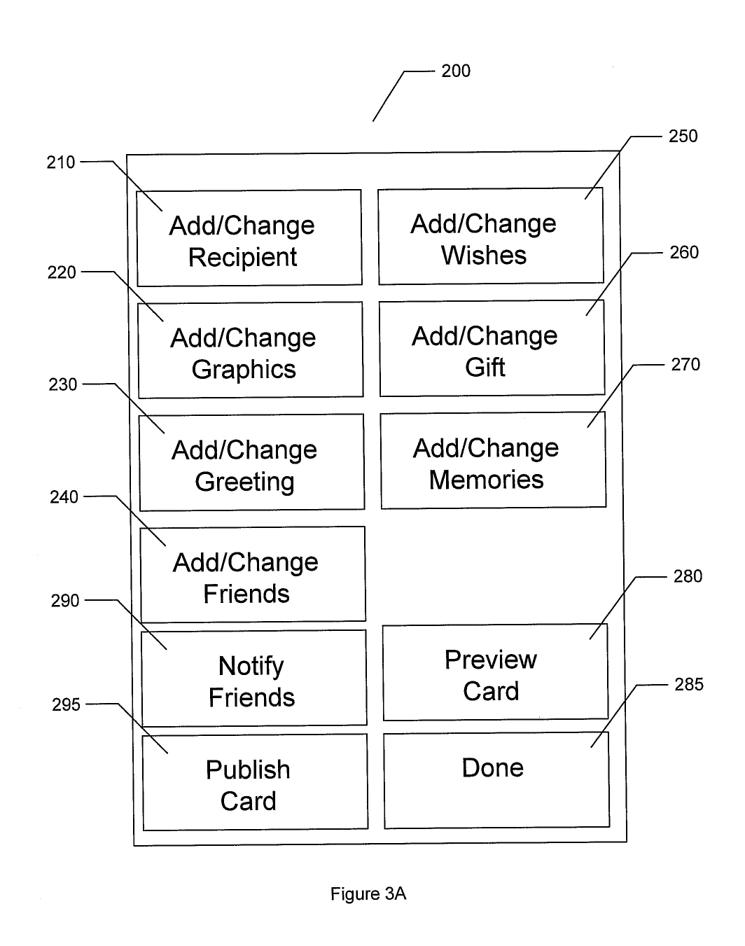

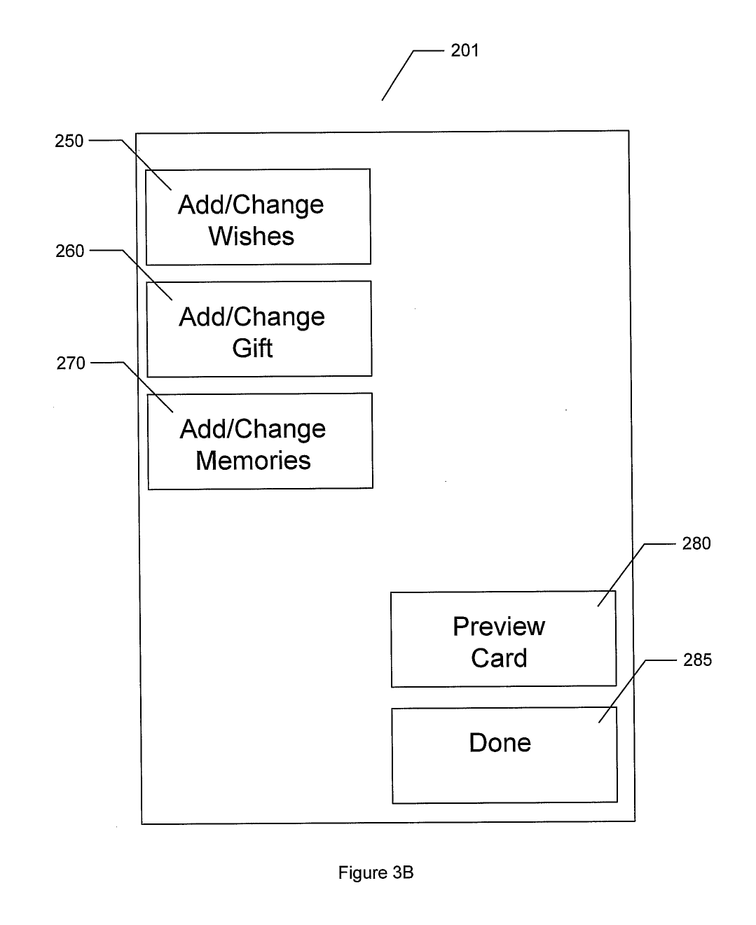

Refer to FIG. 3A, which is a drawing illustrating a host card creator and publishing module of a collaborative e-card creation and publishing platform according to an embodiment of the present invention.

When a member desires to create an e-card and become the host of the card, the member selects the create card option by, for example, clicking an icon labeled “Create E-card”. The member is then designated as the host and is presented with an interface menu comprising multiple actions/options.

In the embodiment illustrated in FIG. 3A, the host card creator interface 200 comprises the options to add/change recipient 210, add/change graphics 220, add/change greeting 230, add/change friends 240, add change wishes 250, add/change gift 260, add/change memories 270, notify friends 290, preview card 280, done 285, and publish card 295.

In an embodiment of the present invention some actions/options are completed directly on the host card creator interface 200.

In an embodiment of the present invention some actions/options are completed on a separate page that is presented after the host selects the option on the host card creator interface 200.

Typically, the first step in creating a collaborative e-card of the present invention is for the host to select or input the recipient using add/change recipient 210. The recipient is the person or persons who will receive the published e-card or are the person or persons that the e-card is intended for. To add the recipient or recipients the host, for example, selects the recipient from a list of friends, inputs the recipient's email address, selects the recipient's user name, selects the recipient's member name, selects the recipient's instant messaging name, or selects the recipient's telephone number.

Add/change graphics 220 allows the host to create the graphical elements for the e-card and to design the feel or style of the e-card. The host can add pictures or photographs, draw pictures such as hearts, funny faces, etc. or graphical elements such as lines, circles, squares, etc., or add text. The host can also choose a theme to apply to the e-card. A theme comprises preset styles such as, for example, colors, boarders, pictures, etc. that are applied to the e-card to provide a uniformed look.

Add/change greeting 230 allows the host to add a main greeting to the card appropriate for the occasion. For example, the host can add a greeting such as “Happy Birthday, John!”, “Happy 30th Anniversary, Mary and Ken!”, “Sorry for your loss, Thomas”, etc. An advantage of the present invention is that the host is allowed to make the greeting personal thereby increasing the emotional impact of the e-card.

Add/change wishes 250 allows the host to add personal wishes and their signature to the e-card. For example, the host can add wishes such as “Hey old man, have a good one!”, “You are an inspiration!”, etc. along with their signature or name “James Cheng”.

Add/change gift 260 allows the host to add a gift to the e-card to be sent to the recipient. For example, the host can add an e-coupon, a gift certificate, etc. to the e-card.

Add/change memories 270 allows the host to add memories such as, for example, photographs, videos, music, poems, letters, etc. to the e-card. For example, the host can add a photograph of the host and recipient.

Add/change friends 240 allows the host to designate people to be invited to participate in collaborating with the e-card. To add the intended participants the host, for example, selects the user from a list of friends, inputs the user's email address, selects the person's user name, selects the user's member name, selects the user's instant messaging name, or selects the user's telephone number.

After the host selects a plurality of intended participants, notify friends 290 invites the intended participants. The intended participants are invited to participate or notified of the opportunity to participate by, for example, email, social network message or invitation, private message, instant message, simple messaging system, or multimedia messaging system. The invitation comprises a hyperlink to direct the user to the e-card.

Preview card 280 allows the host to preview the current state of the e-card.

Done 285 allows the host to exit the various options of the host card creator interface or the host card creator interface itself.

When the host is satisfied that the e-card has been completed, publish card 295 allows the e-card to be published. The e-card is published by sending the e-card, a picture of the e-card, or a hyperlink to the e-card, for example, to a social network, an email, a blog, a bulletin board service, a discussion forum, or a website.

After publishing the collaborative e-card, the e-card is viewable by the recipient or by the recipient, the host, and the user's who collaborated.

In an embodiment of the present invention the host sets the date of the event or when the card should be sent and it is automatically sent on that date.

Refer to FIG. 3B, which is a drawing illustrating a card editor module of a collaborative e-card creation and publishing platform according to an embodiment of the present invention.

When an invited user chooses to collaborate on the e-card they are directed to the user card editor module interface 201.

Similar to the host card creator module interface (200 FIG. 3A), the user card editor module interface 201 allows participating users to perform add/change wishes 250, add/change gift 260, add/change memories 270, preview card 280, and done 285.

In an embodiment of the present invention users are allowed to further edit the design of the e-card created by the host.

In another embodiment of the present invention users are not allowed to further edit the design of the e-card created by the host. Instead, each user is provided with a section of the card to add designs or design elements. This prevents a user from changing or damaging another user's design. For example, user A is provided with a section of the card to add their wishes, signature, graphical elements, drawings, designs etc. and user B is provided with another section of the card to add elements so as not to conflict with user A's content.

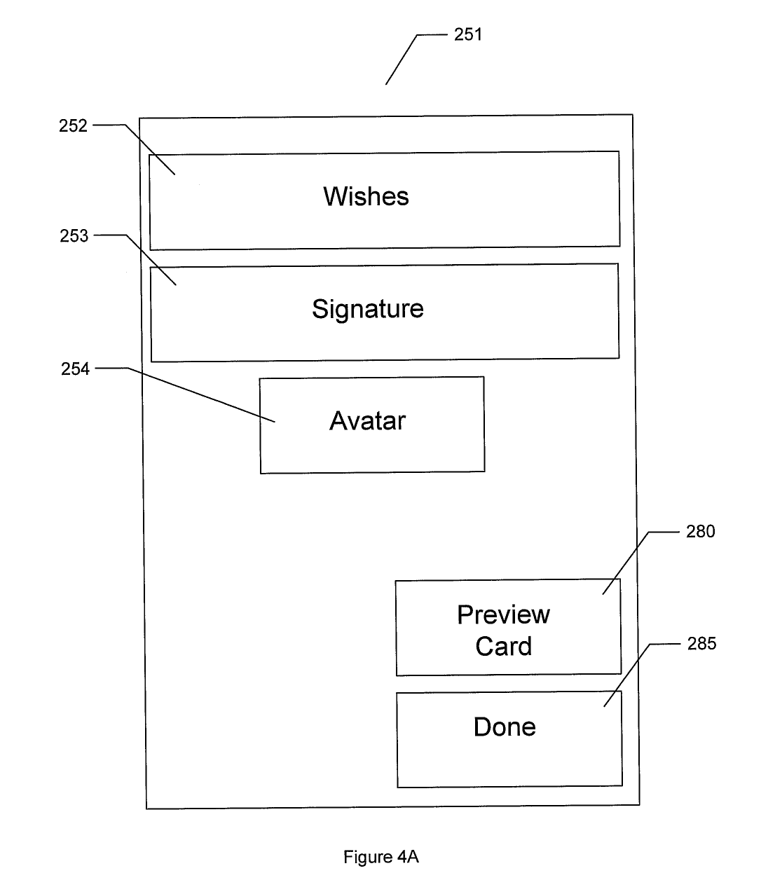

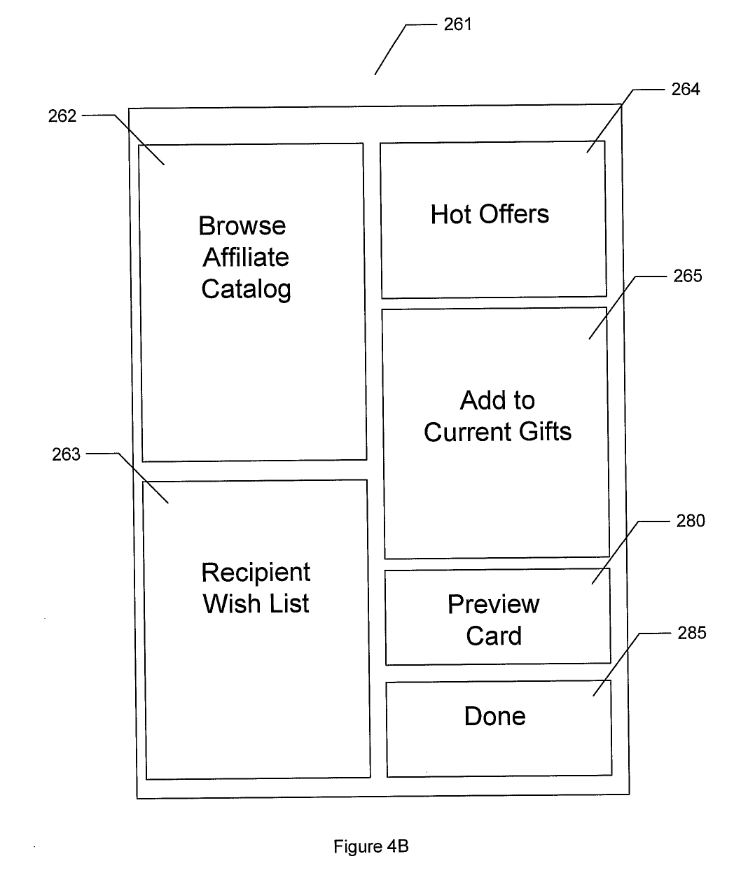

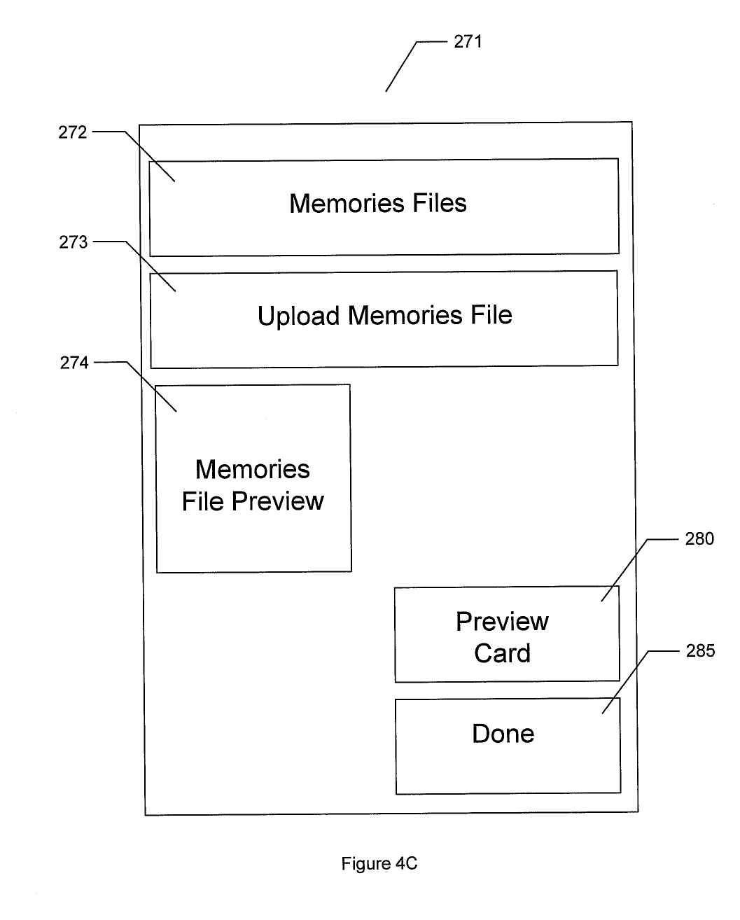

Refer to FIG. 4A, which is a drawing illustrating a signature and wishes editor module of a collaborative e-card creation and publishing platform according to an embodiment of the present invention.

In an embodiment of the present invention selecting add/change wishes presents the user with a signature and wishes editor module 251. The user is allowed to add/edit their wishes 252, their signature 253, or add an avatar 254. The avatar 254 comprises, for example, a photograph, a picture, an icon, a licensed character, a symbol, or a drawing that the user wants to use to represent themselves. After selecting the avatar, the avatar will be displayed along with the user's signature and wishes.

Refer to FIG. 4B, which is a drawing illustrating a gift module of a collaborative e-card creation and publishing platform according to an embodiment of the present invention.

In an embodiment of the present invention selecting add/change gift presents the user with a gift module interface 261. The gift module allows a user to add gifts to the e-card that will be given to the recipient when the e-card is published. The interface allows a user to browse an affiliate catalog 262, view a recipient wish list 263, view hot offers 264, and view and add to current gifts 265.

Browsing the affiliate catalog 262 allows a user to look through a catalog or list of items that can be selected as gifts to add to the e-card. An affiliate network cooperates with the collaborative e-card creating and publishing platform of the present invention to provide products and services to members of the platform for purchase and to be given as gifts.

Members of the platform are allowed to create a wish list of products and services that they would like to receive as gifts. When an e-card is created, the recipient's wish list 263 is displayed and a user can select an item or items from the wish list to give the recipient as gifts. This simplifies the purchasing process and ensures that the recipient receives gifts that they most desire.

Hot offers 264 displays products and services that are being promoted or currently have a special promotion or sale. Advertisers can choose to promote their products or highlight their products in order to attract users to make a purchase.

Add to current gifts 265 displays gifts that have already been selected by other users. By displaying the current gifts, giving duplicate gifts is prevented. Also, if a gift is a gift certificate a user can join with other users to increase the amount of the gift certificate.

The name or signature of the user that gave the gift is associated and displayed with the gift in the e-card so that the recipient knows who gave the gift.

Refer to FIG. 4C, which is a drawing illustrating a memories editor module of a collaborative e-card creation and publishing platform according to an embodiment of the present invention.

In an embodiment of the present invention selecting add/change gift presents the user with a memories module interface 271. The memories module is provided to allow users to add content in addition to their wishes. For example, a user can add photos and videos to the e-card that the recipient will be able to see. This allows the present invention to produce an e-card with much more emotional impact.

The memories module interface 271 displays the user selected memories files 272 and allows the user to upload memories files 273. The user can also preview the memories file 274 to ensure that the correct file has been added or is to be added.

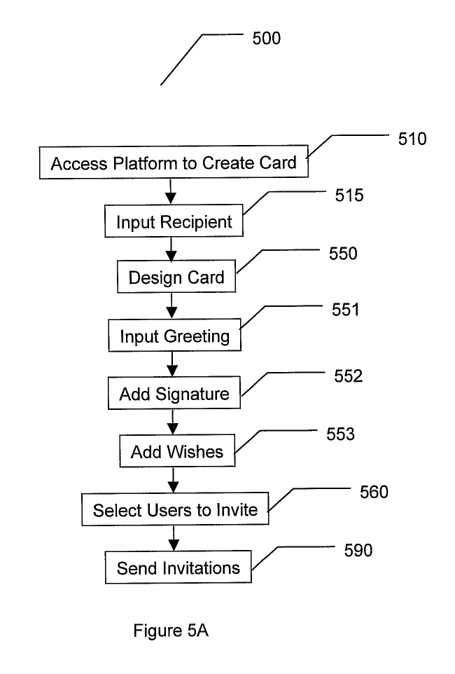

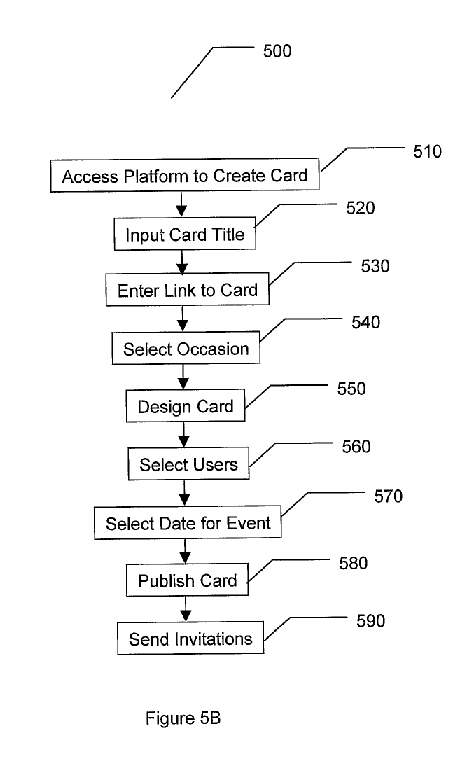

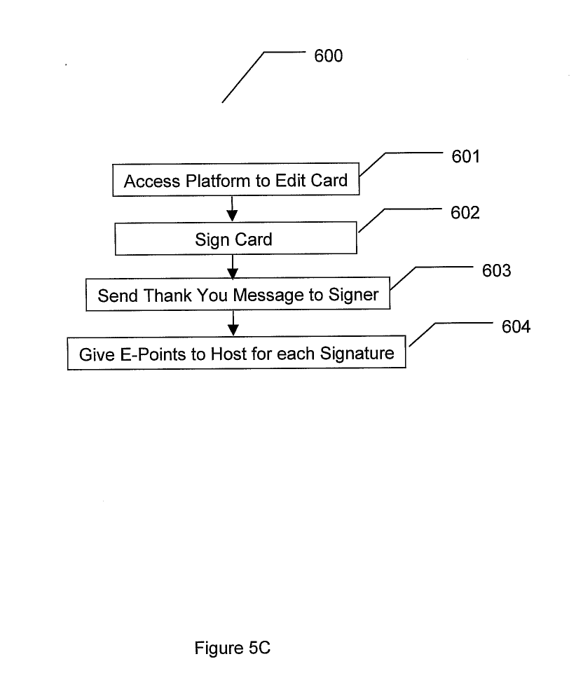

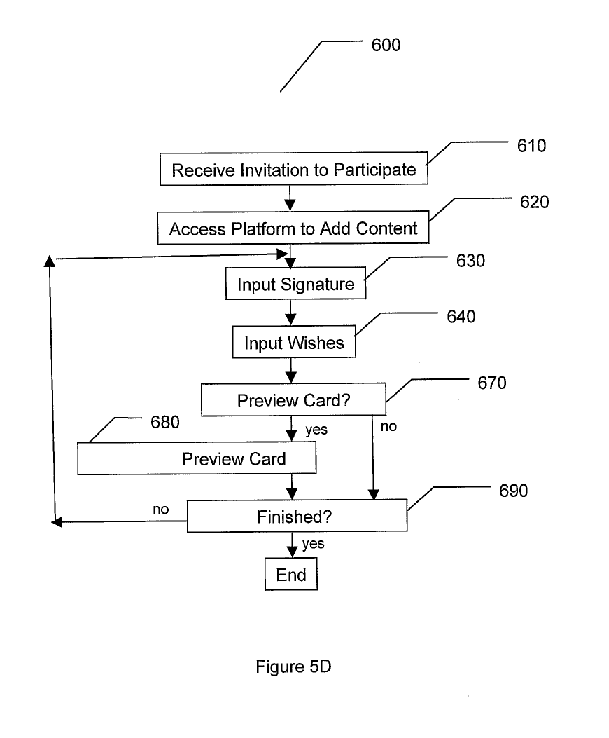

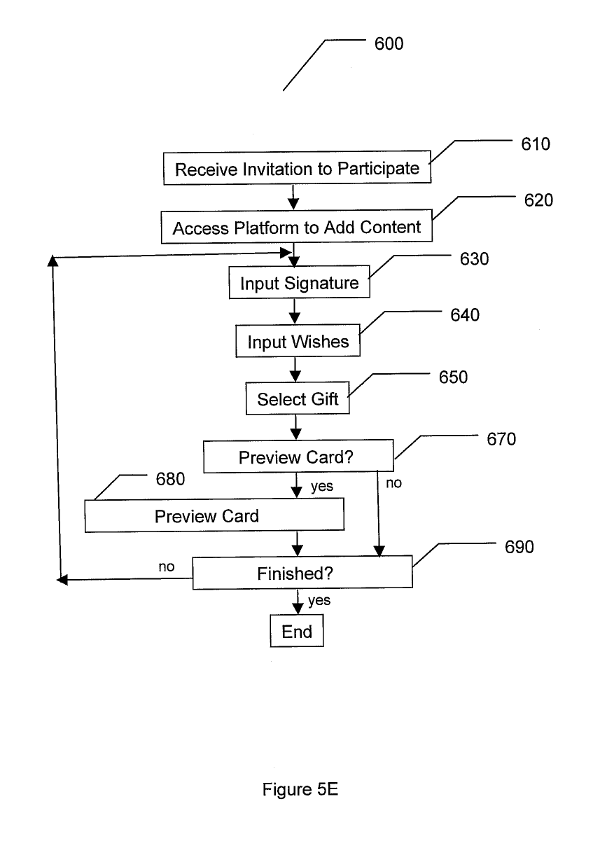

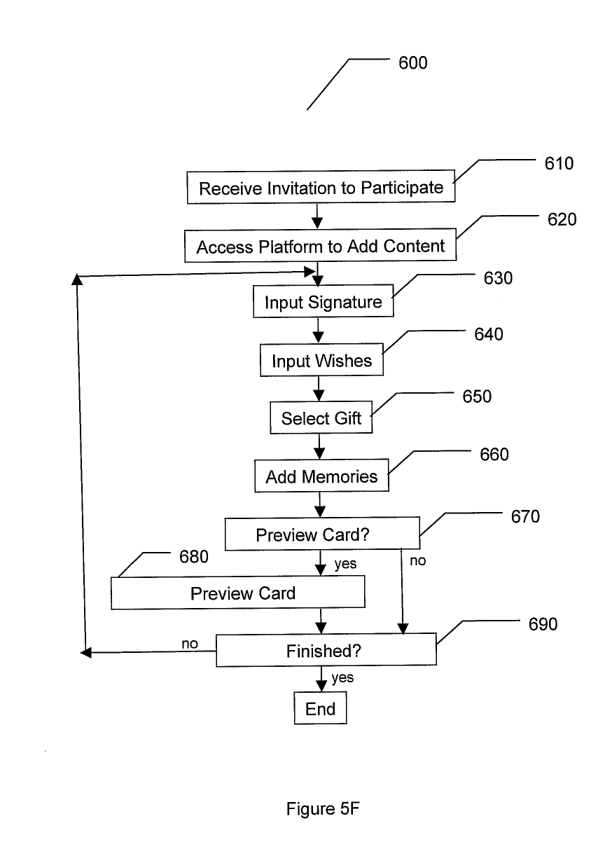

Refer to FIG. 5A, which is a flowchart illustrating a method for e-card creation of a collaborative e-card creation and publishing platform according to an embodiment of the present invention.

In the embodiment illustrated in FIG. 5A the e-card creation method 500 begins by a user accessing the e-card creating and publishing platform to create a collaborative e-card in Step 510. The e-card creating and publishing platform comprises, for example, a website, a website application, a website plug-in module, a social network, or a social network application.

If the user has been invited but is not a member of the platform the user is directed to a registration page to allow the user to become a member of the platform. Once registered the member gains access to the platform.

The user is a registered member or becomes a member of the platform in order to utilize the platform. Once the user has registered, logged into the platform, and selects the option to create an e-card, the user becomes the card creator or card host.

In Step 515 the card host inputs the identification of the card recipient. The identification comprises, for example, the recipient's name, email address, social network identification, user name, or member's identification. The identification allows the recipient to be uniquely identified so that they will be assured of receiving the e-card or receiving notification such as a hyperlink to the e-card.

The host designs the visual appearance of the card in Step 550 by adding, for example, graphics, graphical elements, pictures, photographs, themes, text, or drawings.

The host then adds their signature in Step 552 and their wishes in Step 553. In Step 560 the host selects users to be invited to participate in collaborating on the e-card and in Step 590 invitations to participate are sent to the selected users.

Refer to FIG. 5B, which is a flowchart illustrating a method for e-card creation of a collaborative e-card creation and publishing platform according to an embodiment of the present invention.

In the embodiment illustrated in FIG. 5B the method for e-card creation 500 comprises the host accessing the collaborative e-card creation and publishing platform in order to create an e-card in Step 510. In Step 520 the host inputs the card title or card project name. The host enters a link to the e-card in Step 530. For example, “signecard.com/John's B-Day Card.html”. In an embodiment of the present invention the hyperlink is automatically generated using the card title, host name, and server name. In Step 540 the host selects an occasion that the e-card is celebrating or being sent in response to.

In Step 550 the host designs the visual appearance of the card by adding, for example, graphics, graphical elements, pictures, photographs, themes, text, or drawings. Users are selected to be invited to participate in Step 560.

In Step 570 the host selects a date for the event or a date for sending the e-card or hyperlink to the e-card to the recipient.

The card is published in Step 580 and invitations are sent to the selected users in Step 590.

Refer to FIG. 5C, which is a flowchart illustrating a method for e-card editing of a collaborative e-card creation and publishing platform according to an embodiment of the present invention.

The method for e-card editing of a collaborative e-card 600 illustrated in FIG. 5C comprises a user accessing the collaborative e-card creation and publishing platform to edit or add content in Step 601. In Step 602 the user adds their signature or name and wishes. When finished editing or adding content to the e-card a thank you message for signing the card is sent to the user in Step 603. In Step 604 electronic points (e-points) are given to the host for the signature or participation of the invited user.

Refer to FIG. 5D, which is a flowchart illustrating a method for e-card editing of a collaborative e-card creation and publishing platform according to an embodiment of the present invention.

The method for e-card editing of a collaborative e-card 600 illustrated in FIG. 5D comprises a user receiving and invitation to participate in collaborating on an e-card in Step 610. The user accesses the platform to add content in Step 620. The user adds their signature (Step 630) and their wishes (Step 640). In Step 670 whether or not the user wants to preview the e-card is determined. If the user wants to preview the e-card, the e-card is displayed in Step 680. In Step 690 whether or not the user is finished with editing the e-card is determined. If the user is finished the editing process ends. If the user is not finished the editing process returns to Step 630.

Refer to FIG. 5E, which is a flowchart illustrating a method for e-card editing of a collaborative e-card creation and publishing platform according to an embodiment of the present invention.

The method for e-card editing of a collaborative e-card 600 illustrated in FIG. 5E is similar to the method illustrated in FIG. 5D. However, the method of FIG. 5E further comprises selecting a gift in Step 650 after the user has input their wishes in Step 640.

Refer to FIG. 5F, which is a flowchart illustrating a method for e-card editing of a collaborative e-card creation and publishing platform according to an embodiment of the present invention.

The method for e-card editing of a collaborative e-card 600 illustrated in FIG. 5F is similar to the method illustrated in FIG. 5E. However, the method of FIG. 5F further comprises adding memories in Step 660 after the user has selected a gift in Step 650.

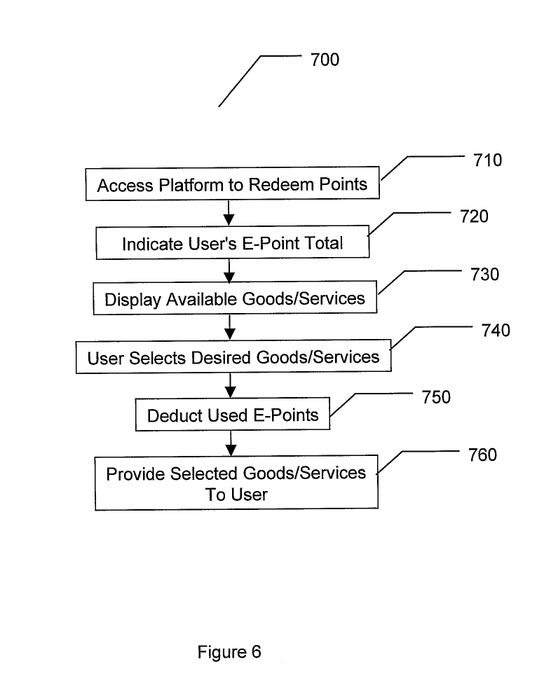

Refer to FIG. 6, which is a flowchart illustrating a method for redeeming electronic points of a collaborative e-card creation and publishing platform according to an embodiment of the present invention.

The method for redeeming e-points 700 illustrated in FIG. 6 comprises the member accessing the platform to redeem points in Step 710. The user's or members e-point total is displayed or indicated in Step 720. In Step 730 available products or services that the e-points can be exchanged for are displayed. The user selects the desired products or services in Step 740. In Step 750 the required e-points for exchange are deducted from the e-points used in the exchange from the user's total. The selected products or services are then provided to the user in Step 760.

In an embodiment of the present invention the collaborative e-card creation and publishing platform further comprises an e-card album website where e-cards can be stored and displayed by users. The e-card album website allows the e-cards to be stored on unique pages for each member. Additionally, the e-cards can be sorted by thumbnail or by calendar for easy access to the e-cards. For example, in calendar view users can switch between months or years on a calendar interface and dates with e-cards are highlighted. Users simply click the date and the e-card for that day is displayed.

In this embodiment users also can copy files that were attached to the e-card in the memories section of the card. This allows for an easy method of storing all the memories such as, for example, photographs and videos for a user in one place. Users can see a lifetime of memories for a user in one place. This also allows for a memories website for a person as a memorial to that person upon their death. For example, when a bereavement e-card is create regarding someone who has passed away, other users can add numerous photographs, videos, text, etc. for over the course of the person's life and these memories files are displayed in one area for that person. Afterwards, many people can see the memories and remember the person's life.

In an embodiment of the present invention the collaborative e-card creation and publishing platform further comprises a list of invited users who have not signed the card yet. Reminders are automatically sent to these invited users to encourage them to participate before the card is published.

In an embodiment of the present invention each user is allowed to choose which of their content is made public or private. For example, the user can select to make their signature and gift public for all users to see and make their wishes and memories private so that only the user and the recipient can view the wishes and memories included by the user.

The user can also select whether to have all content made public or private.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A collaborative electronic card creation platform comprising:
a card creator module for allowing a card host to create an electronic card; and
a card editor module for allowing a plurality of users to add content to the electronic card.

2. The collaborative electronic card creation platform of claim 1, where the card creator module allows the card host to add graphical elements, a greeting, a signature, and wishes when creating the electronic card.

3. The collaborative electronic card creation platform of claim 1, where the card editor module allows the plurality of users to add graphical elements, a signature, and wishes when editing the electronic card.

4. The collaborative electronic card creation platform of claim 3, where the graphical elements, the signature, and the wishes, when viewed by a recipient, are displayed in a linear time mode to appear as if drawn in real-time.

5. The collaborative electronic card creation platform of claim 1, where each user of the plurality of users is allowed to choose which of their content is made public or private.

6. The collaborative electronic card creation platform of claim 1, further comprising:
a publisher module for allowing the card host to publish the electronic card to enable a recipient to view the electronic card.

7. The collaborative electronic card creation platform of claim 6, where the publisher module publishes the electronic card to a social network.

8. The collaborative electronic card creation platform of claim 6, where the publisher module publishes the electronic card to an email.

9. The collaborative electronic card creation platform of claim 1, further comprising:
a gift module for allowing the card host and the plurality of users to select and add products and services to the electronic card to be given to a recipient of the electronic card as gifts.

10. The collaborative electronic card creation platform of claim 1, further comprising:
a memories module for allowing the plurality of users to add multimedia content to the electronic card.

11. The collaborative electronic card creation platform of claim 1, further comprising:
a points module for allowing the card host to receive electronic points for creating an electronic card, having other users sign the electronic card, and having users purchase gifts.

12. The collaborative electronic card creation platform of claim 1, further comprising:
a commerce module for allowing the plurality of users to make purchases, affiliates to offer goods and services for purchase, content providers to offer licensed content, and merchandisers to offer merchandise for sale.

13. The collaborative electronic card creation platform of claim 12, further comprising:
an accounting module for performing financial accounting for commercial activities of the commerce module.

14. The collaborative electronic card creation platform of claim 1, further comprising:
a membership module for maintaining user membership data.

15. The collaborative electronic card creation platform of claim 1, further comprising:
a database for storing collaborative electronic card creation platform information comprising user relationships, member activity, member actions, invited users, card creation, electronic cards, recipients, occasions, dates of activity, dates of occasions, purchases, gifts, values of purchases and gifts, purchasing behavior, user interactions, user behavior, user's friends lists, electronic point exchanges, products, hot offers activity, wish list data, affiliate data, merchandise data, and licensing data or a combination of user relationships, member activity, member actions, invited users, card creation, electronic cards, recipients, occasions, dates of activity, dates of occasions, purchases, gifts, values of purchases and gifts, purchasing behavior, user interactions, user behavior, user's friends lists, electronic point exchanges, products, hot offers activity, wish list data, affiliate data, merchandise data, and licensing data.

16. A collaborative electronic card creation platform comprising:
a card creator module for allowing a card host to create an electronic card, the card host adding card host graphical elements, a greeting, a card host signature, and card host wishes when creating the electronic card;
a card editor module for allowing a plurality of users to add content to the electronic card, the plurality of users adding each user's graphical elements, each user's signature, and each user's wishes when editing the electronic card; and
a publisher module for allowing the card host to publish the electronic card to enable a recipient to view the electronic card.

17. The collaborative electronic card creation platform of claim 16, where each user's graphical elements, each user's signature, and each user's wishes, when viewed by a recipient, are displayed in a linear time mode to appear as if drawn in real-time.

18. The collaborative electronic card creation platform of claim 16, where each user of the plurality of users is allowed to choose which of their content is made public or private.

19. The collaborative electronic card creation platform of claim 16, further comprising:
a gift module for allowing the card host and the plurality of users to select and add products and services to the electronic card to be given to a recipient of the electronic card as gifts.

20. A collaborative electronic card creation platform comprising:
a card creator module for allowing a card host to create an electronic card;
a card editor module for allowing a plurality of users to add content to the electronic card;
where each user of the plurality of users is allowed to choose which of their content is made public or private;
a publisher module for allowing the card host to publish the electronic card to enable a recipient to view the electronic card;
a gift module for allowing the card host and the plurality of users to select and add products and services to the electronic card to be given to the recipient of the electronic card as gifts;
a memories module for allowing the plurality of users to add multimedia content to the electronic card;
a points module for allowing the card host to receive electronic points for creating an electronic card, having other users sign the electronic card, and having users purchase gifts;
a commerce module for allowing the plurality of users to make purchases, affiliates to offer goods and services for purchase, content providers to offer licensed content, and merchandisers to offer merchandise for sale;
an accounting module for performing financial accounting for commercial activities of the commerce module;
a membership module for maintaining user membership data; and
a database for storing collaborative electronic card creation platform information.
